(19) United States
(12) Patent Application Publication
(10) Pub. No.: US 2009/0256520 A1
(43) Pub. Date: Oct. 15, 2009

(54) Portable Notebook Computer with Selectively Exposed Solar Charging Cells

(76) Inventor: Abe Frishman, Carrollton, TX (US)

Correspondence Address: MATTHEW E. BURR, 620 CONGRESS AVENUE, STE 320, AUSTIN, TX, 78701, US

(21) Appl. No.: 12/420,642

(22) Filed: Apr. 8, 2009

Related U.S. Application Data
(60) Provisional application No. 61/043,647, filed on Apr. 9, 2008.

(51) Int. Cl. H01M 10/46

(52) U.S. Cl. 320/101

(57) ABSTRACT

A portable notebook solar charger provides a high-powered power supply, applicable to many PCs throughout the world. Specific embodiments utilize an HCSS Li-ion battery that can charge a notebook, cellular phone, MP3/MP4 players, digital cameras, gaming devices. A discreet selectively openable and closable protective cover protects the solar charging cells in the closed position and opens to expose the solar cells to a suitable light source for charging. Specific embodiments of a solar charging unit are selectively attachable and detachable to a notebook computer. Alternative embodiments provide an integrated solar charger with selectively openable protective cover.

### CROSS-REFERENCE TO RELATED APPLICATIONS

This disclosure is related to and claims the benefit of and priority from U.S. provisional patent application Ser. No. 61/043,647, of the same title and by the same inventor, filed Apr. 9, 2008, the disclosure of which is incorporated herein by reference.

### TECHNICAL FIELD

This disclosure relates generally to solar chargers and in particular to solar charging units adapted to operate with portable notebook computers and other electronic devices to charge batteries in the absence of an electrical outlet.

### BACKGROUND

The terms “notebook” and “laptop” are used interchangeably in the present disclosure to refer to portable computers. It will understood by those skilled in the art that the terms “solar”, “solar-charger” and the like refer to any light sensitive electric cell and is not intended to be limited to cells sensitive only to the Sun. That is, the cells are sensitive to any light source.

Solar cell arrays for charging the batteries of electronic devices such as laptop or notebook computers, cellular phone, MP3/MP4 players, Digital Cameras, Gaming Devices, including Play Station Portable (PSP)®, Nintendo® DX, Nintendo® Lite, Satellite Phones, GPS units and many other related battery charged products are typically provided as stand-alone units that connect to the battery-powered device by means of a cable, wire or plug. The solar charger, therefore, and its accessories, is yet another item or piece of equipment that must be lugged around with the device.

Yet to integrate or attach solar charging cells to the device itself presents problems of size, weight and durability. An integrated solar panel may add size and weight to the portable device, rendering it less portable. The integrated solar cells need to be protected against damage from impacts, weather and so forth, and so some sort of protective covering would be desirable to enhance the durability of the solar cells.

It would, therefore, be useful to provide a solar cell charger configuration for integration or attachment to a portable electronic device such that the cell array does not add significant size or weight increase to the device and where a protective covering discreetly and selectively exposes and protects the cells.

### SUMMARY

A exemplary embodiment of a portable notebook solar charger of the present disclosure may provide a high-powered power supply, applicable to many PCs throughout the world. Specific embodiments of a Solar/AC charger utilize an HCSS Li-ion battery that can charge a notebook, cellular phone, MP3/MP4 players, digital cameras, gaming devices, including Play Station Portable (PSP)®, Nintendo® DX, Nintendo® Lite, Satellite Phones, GPS Units and many other related battery charged products that utilize re-chargeable batteries.

Alternative embodiments of a notebook solar charger of the present disclosure include an AC charging adapter plug so the unit can be charged from an electrical outlet, and some embodiments provide a multi-voltage adapter suitable for almost any electrical outlet in the world throughout the world, in addition to charging from the sun (or any bright light source). The solar charger also serves as a back-up battery supply that ensures power when one is traveling or even camping away from an electrical source.

An advantageous feature of specific embodiments of an integrated solar charger of the present invention may be found in the integrated selectively sliding protective panels that provide discreet means to selectively protect the solar array when the protective panels are in a close position and to expose the photo-sensitive array to light when the panels are in the open position.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a perspective view diagrammatic illustration of an exemplary embodiment of an open notebook computer having integrated solar charging cells of the present disclosure.

FIG. 2 is a side view cross-section illustration of the notebook computer of FIG. 1 in a closed position.

FIG. 3 is a top view diagrammatic illustration of the notebook computer of FIG. 1 in a closed position with the solar cell protective cover closed.

FIG. 4 is a top view diagrammatic illustration of the notebook computer of FIG. 3 in a closed position with the protective cover open to expose the integrated solar cells.

### DETAILED DESCRIPTION

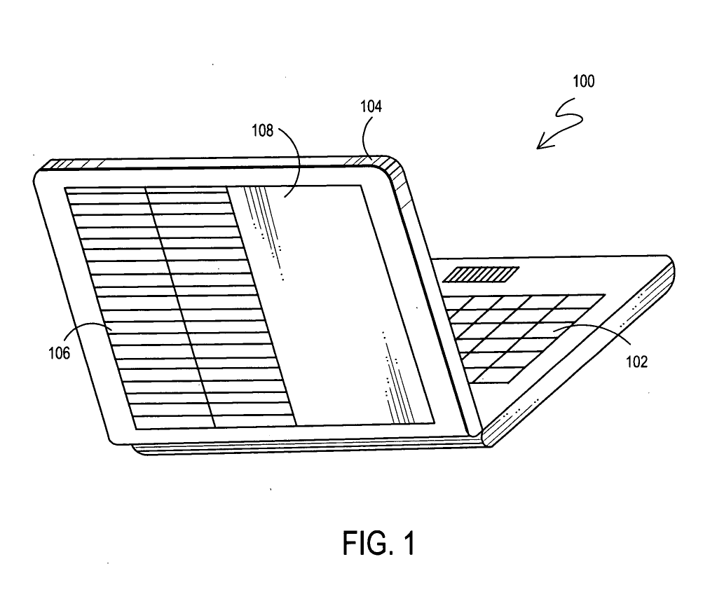

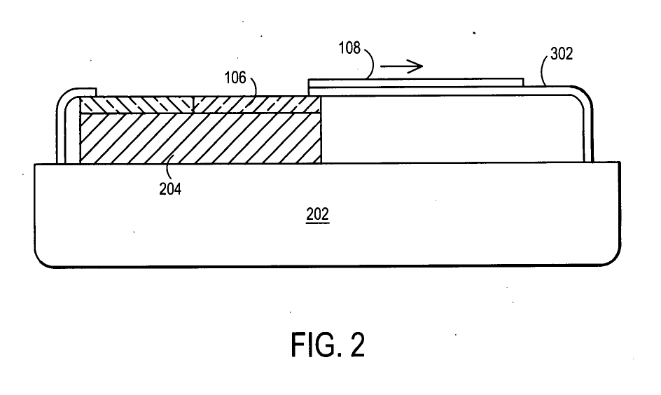

Referring to FIG. 1 of the drawings, FIG. 1 is a perspective view diagrammatic illustration of an exemplary embodiment of an open notebook computer having integrated solar charging cells of the present disclosure. The reference numeral 100 generally designates a portable notebook computer embodying features described in the present disclosure with selectively exposable solar charging cells integrated into a housing for charging batteries so that the computer can be selectively operated with battery power (battery mode) rather with power supplied through a standard electrical outlet. The notebook 100 includes a keyboard 102 on the bottom and a monitor (obscured in this view) on the top 104. Solar charging cells 106 are integrated into top 104 and are in electrical communication with batteries 204 (see FIG. 2). Selectively openable solar cell protective covering 108 is illustrated in FIG. 1 in the open position to exposed solar or other photo-sensitive cells 106 to a light source for electrical charging. Photocells 106 respond to incident light by generating an electric current which charge batteries 204.

FIG. 2 is a side view cross-section illustration of the notebook computer of FIG. 1 in a closed position. Laptop body 202 is in electrical communication with battery unit 204 disposed on top of body 202. Selectively openable solar cell protective covering 108 is in the open position to expose solar cells 106, in photo-electrical communication with battery unit 204, to a light source having sufficient power to generate photo-electric energy to charge the batteries in battery unit 204.

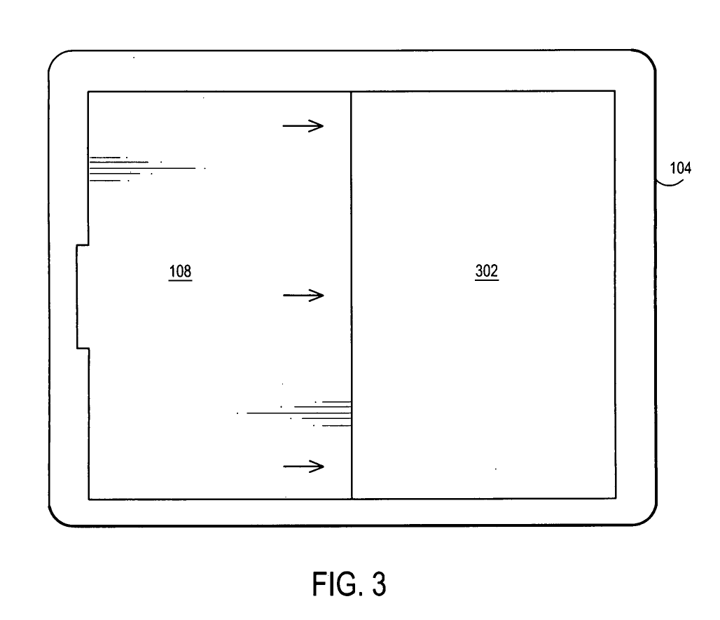

FIG. 3 is a top view diagrammatic illustration of the notebook computer of FIG. 1 in a closed position with the solar cell protective cover closed. Selectively openable solar cell protective covering 108 is closed over solar cells 106 (not visible in this view) to protect the solar cells 106. When cover 108 is in the closed protective position, the top surface 302 of notebook top 104 is exposed.

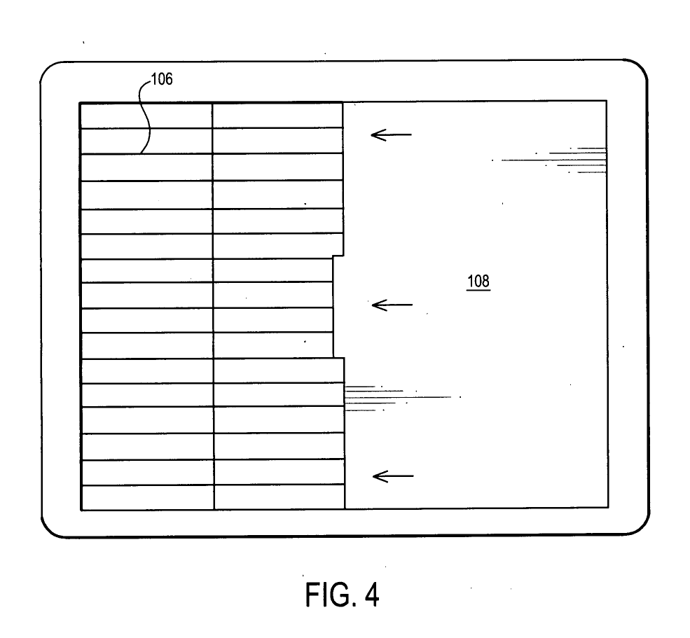

FIG. 4 is a top view diagrammatic illustration of the notebook computer of FIG. 3 in a closed position with the protective cover open to expose the integrated solar cells. In contrast to FIG. 3, in FIG. 4, protective cover 108 is opened and now covers top surface 302, as shown also in cross section in FIG. 2, and exposes solar charging cell 106. Protective cover 108 slides open to the Right. Cover panel 108 slides under the top portion 302 of the cover that is permanent. Solar charging unit may be attached to the back panel of any notebook using, for example, screws. Specific embodiments of solar charging unit 106 may provide AC prongs. USB cord, for example, connects with the power port on the back of the notebook to supply constant charge when exposed to solar light or any bright light source.

In a preferred embodiment, protective cover 108 is substantially opaque and slides along surface 302, for example, in a tongue and groove arrangement, to keep the space required to reveal charging cells 106 to an approximate minimum. The sliding mechanism may be optimized for space consideration by sizing the solar cell panel 106 and protective cover 108 so that each occupies approximately half of the surface of the top of notebook 104 such that when protective cover 108 is open to reveal panel 106 there is no or little overhang from surface 302.

Other mechanisms or arrangements, however, may be contemplated by those skilled in the art. For example, a hinged mechanism that allows protective cover 108 to open like a door or wing would permit a larger array of solar cells on top 104 than would the sliding mechanism but would require more space to open.

A further alternative embodiment utilizes an accordion bunching mechanism for cover 108 to selectively expose cells 106. Yet another alternative embodiment utilizes a “roll-top” mechanism where cover 108 is flexible so that it can bendably and selectively dispose into a compartment housed in top 104, for example.

Particular embodiments provide a selectively attachable and detachable solar charging unit having solar cell panel 106 and protective cover 108 that can be selectively attached to top 104 of notebook 100 and connected to the regular power supply socket of notebook 100 by means of a cable or wire, for example. Such embodiments may be selectively attachable by means of an adhesive, Velcro, straps or other suitable that allow the embodiment to attach to virtually any laptop. Yet further embodiments may provide attachment means that are substantially permanent yet allow one to purchase a solar charging unit of the present disclosure and attach it substantially permanently to a pre-existing laptop that one already owns. Still further alternative embodiments may provide a kit that includes a laptop or other electronic device, a selectively attachable solar charger of the present disclosure together with one or more of the accessories described herein below, and instructions for using the solar charger with the device.

Alternative embodiments provide a notebook computer having a solar charging unit of the present disclosure integrated into the housing of the notebook.

Preferred embodiments of a solar charging unit of the present disclosure may include but not be limited to the specifications and features described herein.

Certain embodiments may provide an AC charger/adapter that may provide high-powered power supply so the unit's batteries can be selectively charged from the sun (any bright light source) or by any electrical outlet throughout the world. For international use such an adapter may be multi-modal so selectively operate with the various local voltages around the world. Battery unit 204 may utilize an HCSS Li-ion battery that can charge a notebook, cellular Portable Notebook Computer with Selectively Exposed Solar Charging Cells phone, MP3/MP4 players, Digital Cameras, Gaming Devices, including Play Station Portable (PSP)®, Nintendo DX®, Nintendo® Lite, Satellite Phones, GPS Units and many other related battery charged products.

Case Dimensions (Preferred)

10.8″ L×8.1″ W×1.1″ H

Solar Panel Dimensions:

8.5″ L×6.5″ W×0.1″ H

Additional Equipment (Kit Embodiments):
AC Cable (1)
USB Cable (1)
Operating Instructions (1)
Notebook Tips (9)
Car Charger Cable (1)

Specifications (Preferred)

1. Solar Panel: Mono Crystalline Solar Panel

2. Solar Panel Square: 0.071 sq. m

3. High Voltage: 14.5V

4. High Electric Current: 650 mA

5. Li-Ion Cell Capacity: 3000 mAh-10.8V

6. Output Voltage: 4.5V; 8.4V; 13.7V; 17.5V; 4.5V (350 mA) for Cellular Phone or 1.2V Battery for Charging; 8.4V (350 mA) for Digital Camera or 7.2V Batter for Charging; 13.7V (450 mA) for 12V Battery for Charging or 12V input AC Power; 17.5V (1500 mA) for use with Notebook Battery Charging.

7. Solar Charge Time (Approximate): 5 to 6 Hours

8. AC Charge Time (Approximate): 3 Hours

9. Operational Time: 3 Hours (Varies based on PC Brands and Operations/programs)

10. Input AC: AC 100 240V; 50/60 Hz (Worldwide Use)

11. Input DC: DC 10-14V

12. Operating Temperature: 14° F. to 104° F. (−10° C. to 40° C.)

13. Storage, Transportation Temp −4° F. to 122° F. (−20° C. to 50° C.)

14. Power indicator: LED Bulb shows Green (Sully Charged)

LED Bulb shows Red (Indicates Charging in Progress).

Electronic devices including laptop computers and cell phones typically have a battery charging port or socket adapted to receive a particular charging connector tip. For example, some tips have a double prong that fits into a slot on the device whereas other tips may be familiar female receptacles that fit over a male counterpart on the device. Conversely, the connector tip may be a male prong that fits into a female receptacle on the device. Such male-female connections may be further diversified by being of varying diameters depending on the brand of device, for example. Accordingly, the present disclosure contemplates providing a plurality of connectors having various tips to fit a variety of device battery charging ports.

Alternative embodiments provide a carrier such as briefcase adapted to hold the laptop or other battery-powered electronic device and also adapted to hold one or more of the photocells. Specific embodiments may be further adapted to hold one or more of the plurality of connectors described above.

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

I claim:

1. A portable electronic device, wherein the device has a mode to operate on battery power, the device comprising:
at least one battery to power the device;
one or more photocells capable of generating an electric current, wherein at least one of the photocells is in electric communication with at least one battery; and
a photocell cover associated with at least one of the photocells, wherein the cover is selectively adjustable to cover or uncover at least one photocell,
wherein at least one battery is chargeable by at least one photocell.

2. The device of claim 1, further comprising a housing for the device and wherein at least one photocell is integrated into the housing.

3. The device of claim 2, wherein the photocell cover is slidably integrated with the housing such that the cover selectively uncovers one or more photocells and selectively covers one or more photocells.

4. The device of claim 2, wherein the photocell cover is rolltop integrated into the housing.

5. The device of claim 2, wherein the photocell cover is bendably integrated into the housing to selectively uncover and cover at least one photocell with an accordion-type contraction or expansion, respectively.

6. The device of claim 1, further comprising an electrical connector and wherein at least one photocell is connected to at least one battery by the connector.

7. The device of claim 1, wherein the device comprises a notebook computer.

8. The device of claim 1, wherein the device comprises an MP3 player.

9. The device of claim 1, wherein the device comprises a gaming device.

10. A laptop computer assembly comprising:
One or more batteries to power the computer;
one or more photocells capable of generating an electric current;
at least one electric connector to selectively connect at least one photocell to at least one of the batteries to charge the battery;
a cover associated with at least one of the photocells, wherein the cover is selectively adjustable to cover or uncover at least one photocell; and
a laptop computer housing adapted to house at least one of the batteries selectively attached to the electrical connector.

11. The laptop computer assembly of claim 10, further comprising an AC adapter selectively connectable to at least one of the batteries and also selectively connectable to an electric outlet to charge the battery with a standard electric current.

12. The laptop computer assembly of claim 10, further comprising a carrier to carry the laptop, wherein the carrier houses one or more of the photocells.

13. The laptop computer assembly of claim 12, wherein the carrier is adapted to hold a plurality of electrical connectors of varying types.

14. A kit for a solar-charged battery powered electronic device, the kit comprising:
One or more batteries to power the device;
one or more photocells capable of generating an electric current;
at least one electric connector to selectively connect at least one photocell to at least one of the batteries to charge the battery;
a cover associated with at least one of the photocells, wherein the cover is selectively adjustable to cover or uncover at least one photocell; and
a device housing adapted to house at least one of the batteries selectively attached to the electrical connector;
at least one AC adapter;
at least one USB cable;
at least one car charger connector; and
a set of operating instructions.

15. The kit of claim 15, further comprising a carrier for the device, wherein the carrier houses one or more of the photocells.

16. The kit of claim 14, further comprising a plurality of electrical connectors, wherein each connector has a tip adapted for connection to a particular type of battery charging socket.

17. The kit of claim 16, further comprising a carrier for the device, wherein the carrier is adapted to hold one or more or of the plurality of connectors.
